(19) United States
(12) Patent Application Publication
(10) Pub. No.: US 2026/0003837 A1
(43) Pub. Date: Jan. 1, 2026

(54) DATA CONFLICT RESOLUTION AND STORAGE OPTIMIZATION

(71) Applicant: Twilio Inc., San Francisco, CA (US)

(72) Inventors: Aaron Klish, San Francisco, CA (US); Atit Shah, San Francisco, CA (US); Anand Ramakrishnan, San Francisco, CA (US); Jayakrishnan Nair, San Francisco, CA (US); Emma Sims, San Francisco, CA (US)

(21) Appl. No.: 18/759,104

(22) Filed: Jun. 28, 2024

(51) Int. Cl. G06F 16/2455; G06F 16/23

(52) U.S. Cl. CPC G06F 16/215; G06F 16/2365

(57) ABSTRACT

Various embodiments described herein support or provide operations for facilitating the reconciliation and storage of conflicting user data across multiple platforms. Specifically, an audit record that includes a plurality of data records of an attribute is identified. A consolidated data record of the attribute in a summary record is generated. A current value of the attribute is determined based on the consolidated data record of the attribute in the summary record. The current value of the attribute is stored in a final record for downstream processing.

### TECHNICAL FIELD

The present disclosure generally relates to data management. More particularly, various embodiments described herein provide for systems, methods, techniques, instruction sequences, and devices that facilitate efficient reconciliation and storage of conflicting user data across multiple platforms.

### BACKGROUND

In modern digital environments, data is collected from various sources and platforms, including desktop computers, mobile devices, and other connected technologies. This data often includes user preferences, actions, and interactions used to build comprehensive user profiles. As users interact with multiple platforms and sessions, discrepancies and conflicts in data values can arise. Managing these discrepancies to ensure data integrity and consistency across systems presents a complex challenge, particularly when dealing with large volumes of data that may change over time. Efficiently handling these data conflicts while maintaining a streamlined database structure is a continual challenge in data management practices.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system that facilitates reconciliation and storage of conflicting user data across multiple platforms, according to various embodiments of the present disclosure.

FIG. 3 is a flowchart illustrating an example method for facilitating reconciliation and storage of conflicting user data across multiple platforms, according to various embodiments of the present disclosure.

FIG. 4 is a flowchart illustrating an example method for facilitating reconciliation and storage of conflicting user data across multiple platforms, according to various embodiments of the present disclosure.

FIG. 5 is a flowchart illustrating an example method for facilitating reconciliation and storage of conflicting user data across multiple platforms, according to various embodiments of the present disclosure.

FIG. 6 is a flowchart illustrating an example method for facilitating reconciliation and storage of conflicting user data across multiple platforms, according to various embodiments of the present disclosure.

FIG. 7 is a flowchart illustrating an example method for facilitating reconciliation and storage of conflicting user data across multiple platforms, according to various embodiments of the present disclosure.

FIGS. 8 and 9 illustrate a spreadsheet showing an example audit record, an example summary record, and an example final record associated with attribute values collected for a user over a period of time, according to various embodiments of the present disclosure.

FIG. 10 is a block diagram illustrating a representative software architecture, which may be used in conjunction with various hardware architectures herein described, according to various embodiments of the present disclosure.

FIG. 11 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments include systems, methods, and non-transitory computer-readable media that facilitate consent management and compliance with user consent preferences across multiple platforms, according to various embodiments of the present disclosure. In the realm of data management, particularly in environments where data is collected from multiple sources such as desktops, mobile devices, and other digital platforms, the challenge of handling conflicting data entries is prevalent. Various embodiments involve technologies that address these conflicts by managing and storing data in a way that reduces complexity and maintains data integrity over time.

Conflicting data can result from data consolidation from various sources, including profile merging. For example, when a user interacts with a system such as a website or application, they often do so anonymously. During this anonymous phase, the system may gather various data points such as consent preferences, user details, page views, and clicks, which contribute to the creation of an anonymous user profile. However, when the user decides to register or log in, thereby identifying themselves, the system faces the task of consolidating the anonymous user profile with any existing identified user profile from previous sessions.

This process of merging user profiles can involve combining an anonymous profile with an identified one, managing multiple anonymous profiles, and dealing with multiple identified profiles. Such profile merging can lead to conflicts in data values across these various profiles.

To address these challenges, various embodiments disclose a data conflict resolution approach involving data reconciliation using an audit record, a summary record, and a final record (also referred to as a golden record). Each of these records plays a distinct role in the process of data reconciliation and storage.

The audit record serves as a comprehensive log of all data as it is initially collected along with the corresponding value of the final record after ingestion. Recording the final value provides the ability to retrieve the final value at any point of time in the past. Recording the initial data allows the recreation of the final value used to correct errors or replay data after changing the parameters of the summary records, such as data retention. This record is crucial for maintaining a historical account of all user interactions and changes over time. It is typically stored in a low-cost, long-term storage solution, which makes it economically viable to retain large volumes of data for extended period of time.

The summary record is a consolidated view of the conflicting data. It is designed to store a limited number of entries, which are determined by a predefined threshold. This record can be dynamically updated as new data comes in and conflicts are resolved based on recent entries. The summary record is stored in active storage, which allows for quicker access and processing compared to the audit record. This component is particularly useful for systems that require frequent access to updated data without the need to query the entire history of a user's data. A user profile may include a plurality of summary records, each of which corresponds to a persona stored in the user profile.

The final record represents the final version of the user data after all conflicts have been resolved (across multiple summary records). It is also stored in active storage and is used by downstream systems for further processing or decision-making. This record is critical for ensuring that the most accurate and up-to-date information is available for operational use.

In various embodiments, when data is collected from various user interactions across different platforms, a data management system ingests and logs the data into the audit record. When discrepancies are detected, such as conflicting data entries from multiple sessions or devices, the summary record comes into play. Specifically, the data management system processes and merges data entries based on certain criteria, such as the most recent values or the consolidation of entries under the same session identifiers.

For example, if a user has interacted with a service (via an application) from multiple devices, each interaction might be logged with different session identifiers. The data management system merges these entries in the summary record, keeping the most recent data values and their respective timestamps.

This helps maintain a clear and concise view of the user's current preferences or status without the need to process the entire data history.

Once the data management system processes and stores the entries in the summary record, the resulting data is moved to the final record. The final record holds the resolved data that is considered the most accurate representation of the user's current state. The final record can be utilized by other systems for further processing, analysis, or decision-making.

Various embodiments provide mechanisms for purging outdated data. For instance, the summary record may be configured to purge data older than a predefined period of time (e.g., seven days). This helps manage storage costs and ensures that the system does not dispense computing resources more than necessary to handle outdated and/or irrelevant data.

Additionally, various embodiments allow for the reconstruction of data states at specific points in time. This is particularly useful for audit purposes or for resolving disputes. By leveraging the audit record, it is possible to backtrack and reconstruct the sequence of events leading to the current state of the data.

In summary, the described examples provide a structured approach to managing and resolving data conflicts in environments with multiple data sources. By efficiently processing and storing data through the use of audit, summary, and final records, these technologies help maintain data integrity, reduce storage costs, and improve the speed of data processing. This approach not only addresses the challenges of data conflict resolution but also supports the operational needs of modern digital systems.

In various embodiments, a data management system identifies an audit record that includes a plurality of data records of an attribute (e.g., consent preference on the use of personal data). A user profile can include a variety of attributes that provide a comprehensive understanding of an individual user. For example, a user profile can include a user identifier, age, gender, location, language preferences, and other relevant demographic details. An example user profile can also include consent preferences (e.g., opt-in or opt-out preferences for data collection and marketing communications), user traits (e.g., attributes assigned to the user based on their behavior, preferences, or other criteria defined by the business), user behavioral data (e.g., interaction with webpages, page views, clicks), event history (e.g., sign-ups, purchases, subscriptions), purchase history, engagement metrics (e.g., session duration, frequency of visits), etc.

In various embodiments, the data management system generates a consolidated data record of the attribute in a summary record based on the plurality of data records of the attribute.

In various embodiments, the operation of the generating of the consolidated data record can include the following operations. The data management system purges one or more data records collected earlier than a predetermined time period (e.g., seven days, thirty days), merges at least a portion of the plurality of data records with the same session identifier while keeping a recent value of the attribute in the plurality of data records, and merges at least a portion of the plurality of data records with different session identifiers while keeping respective values of the attribute along with respective timestamps included in the plurality of data records.

In various embodiments, the data management system determines the current value of an attribute based on the consolidated data record of the attribute in the summary record and stores it in a final record for downstream processing.

In various embodiments, the plurality of data records of the attribute is associated with a user identifier corresponding to one or more session identifiers across a plurality of user devices.

In various embodiments, the attribute corresponds to consent preference configured by a user associated with a user identifier. The plurality of data records of the attribute includes the consent preference configured by the user over a period of time across a plurality of user devices.

In various embodiments, the audit record is stored in a low-cost archive data storage for long-term data backup retention. The summary record and the final record are stored in one or more key-value databases.

In various embodiments, the summary record is configured to allow a number of data entries up to a threshold value (e.g., 3).

In various embodiments, the data management system identifies a plurality of data entries in the consolidated data record of the attribute from the summary record.

In various embodiments, the data management system determines that all data values of the attribute in the plurality of data entries correspond to the same value. The system identifies this value as the current value of the attribute to be stored in the final record.

In various embodiments, the data management system determines that all data values of the attribute in the plurality of data entries correspond to different values. The data management system determines a value (e.g., a value representing “conflict”) as the current value of the attribute. The value represents conflicting values collected for the attribute.

In various embodiments, the data management system receives a request to reconstruct a data record from the plurality of data records of the attribute associated with a user identifier back to a point in time in the past. The data management system reconstructs the data record based on the audit record and/or the final record generated based on the data record. The reconstructed data record includes the user identifier, a session identifier, and a value of the attribute collected at a timestamp corresponding to the point in time in the past.

In various embodiments, each of the audit record, the summary record, and the final record can include one or more database rows. Each of the audit record, the summary record, and the final record can include (or be represented by) one or more JavaScript Object Notation (JSON) objects.

Reference will now be made in detail to embodiments of the present disclosure, examples of which are illustrated in the appended drawings. The present disclosure may, however, be embodied in many different forms and should not be construed as being limited to the embodiments set forth herein.

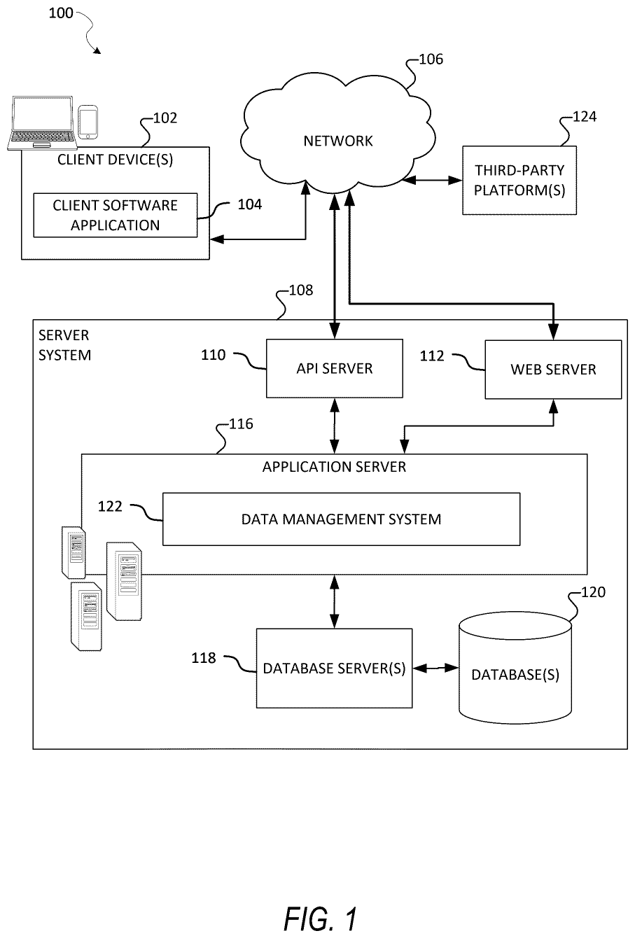

FIG. 1 is a block diagram showing an example data system 100 that includes a data management system 122 (also referred to as system 122), according to various embodiments of the present disclosure. By including the data management system 122, the data system 100 can facilitate reconciliation and storage of conflicting user data across multiple platforms. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

Through one or more web-based interfaces (e.g., web-based user interfaces), the web server 112 can support various functionality of the data management system 122 of the application server 116.

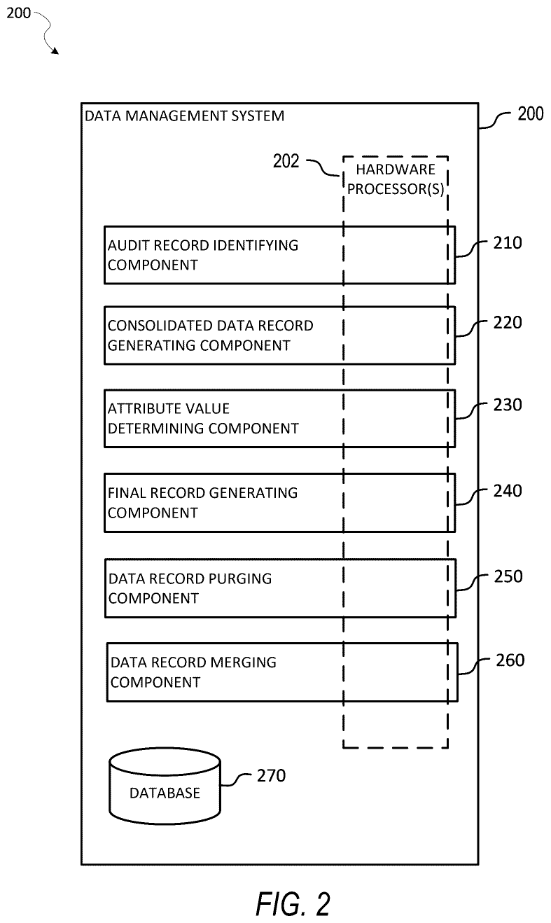

FIG. 2 is a block diagram illustrating an example data management system 200 that facilitates reconciliation and storage of conflicting user data across multiple platforms, according to various embodiments of the present disclosure. For some embodiments, the data management system 200 represents an example of the data management system 122 described with respect to FIG. 1. As shown, the data management system 200 comprises an audit record identifying component 210, a consolidated data record generating component 220, an attribute value determining component 230, a final record generating component 240, a data record purging component 250, a data record merging component 260. According to various embodiments, one or more of the audit record identifying component 210, the consolidated data record generating component 220, the attribute value determining component 230, the final record generating component 240, the data record purging component 250, the data record merging component 260 are implemented by one or more hardware processors 202. Data generated by one or more of the audit record identifying component 210, the consolidated data record generating component 220, the attribute value determining component 230, the final record generating component 240, the data record purging component 250, the data record merging component 260 may be stored in a database (or datastore) 270 of the data management system 200.

The audit record identifying component 210 is configured to identify an audit record that includes a plurality of data records of an attribute (e.g., consent preference on the use of personal data). The audit record serves as a comprehensive log of all data as it is initially collected. This record is crucial for maintaining a historical account of all user interactions and changes over time. It is typically stored in a low-cost, long-term storage solution, which makes it economically viable to retain large volumes of data for extended period of time.

The consolidated data record generating component 220 is configured to generate a consolidated data record of the attribute in a summary record based on the plurality of data records of the attribute. The summary record is a consolidated view of the conflicting data. It is designed to store a limited number of entries, which are determined by a predefined threshold. This record can be dynamically updated as new data comes in and conflicts are resolved based on recent entries. The summary record is stored in active storage, which allows for quicker access and processing compared to the audit record. This component is particularly useful for systems that require frequent access to updated data without the need to query the entire history of a user's data.

The attribute value determining component 230 is configured to determine the current value of an attribute based on the consolidated data record of the attribute in the summary record.

The final record generating component 240 is configured to generate (or identify) a final record of attributes and stores the current values of attributes determined by the attribute value determining component 230 in the final record for downstream processing.

The final record represents the final version of the user data after all conflicts have been resolved. It is also stored in active storage and is used by downstream systems for further processing or decision-making. This record is critical for ensuring that the most accurate and up-to-date information is available for operational use.

The data record purging component 250 is configured to purge one or more data records collected earlier than a predetermined time period (e.g., seven days, thirty days)

The data record merging component 260 is configured to merge at least a portion of a plurality of data records from an audit record with the same session identifier while keeping a recent value of the attribute in the plurality of data records. The data record merging component 260 is further configured to merge at least a portion of the plurality of data records with different session identifiers while keeping respective values of the attribute along with respective timestamps included in the plurality of data records.

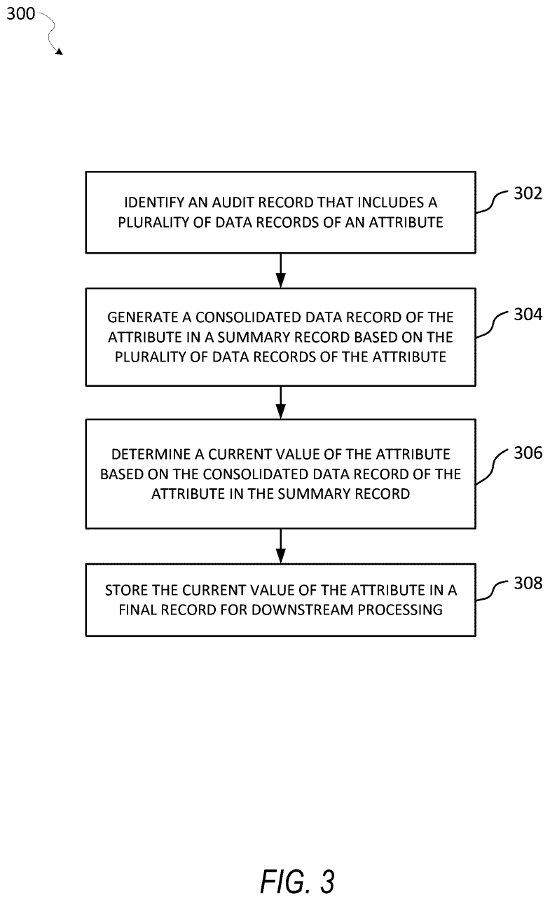

FIG. 3 is a flowchart illustrating an example method 300 for facilitating reconciliation and storage of conflicting user data across multiple platforms, according to various embodiments of the present disclosure. It will be understood that example methods described herein may be performed by a machine in accordance with some embodiments. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor identifies an audit record that includes a plurality of data records of an attribute (e.g., consent preference on the use of personal data). The audit record serves as a comprehensive log of all data as it is initially collected. This record is crucial for maintaining a historical account of all user interactions and changes over time. It is typically stored in a low-cost, long-term storage solution, which makes it economically viable to retain large volumes of data for extended period of time.

At operation 304, a processor generates a consolidated data record of the attribute in a summary record based on the plurality of data records of the attribute. The summary record is a consolidated view of the conflicting data. It is designed to store a limited number of entries, which are determined by a predefined threshold. This record can be dynamically updated as new data comes in and conflicts are resolved based on recent entries. The summary record is stored in active storage, which allows for quicker access and processing compared to the audit record. This component is particularly useful for systems that require frequent access to updated data without the need to query the entire history of a user's data.

At operation 306, a processor determines the current value of the attribute based on the consolidated data record of the attribute in the summary record.

At operation 308, a processor stores the current value of the attribute in a final record for downstream processing. In various embodiments, a processor generates (or identifies) a final record and stores the current values of attributes in the final record for downstream processing, analysis, and/or decision-making.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 308 or, alternatively, form part of one or more of operations 302 through 308.

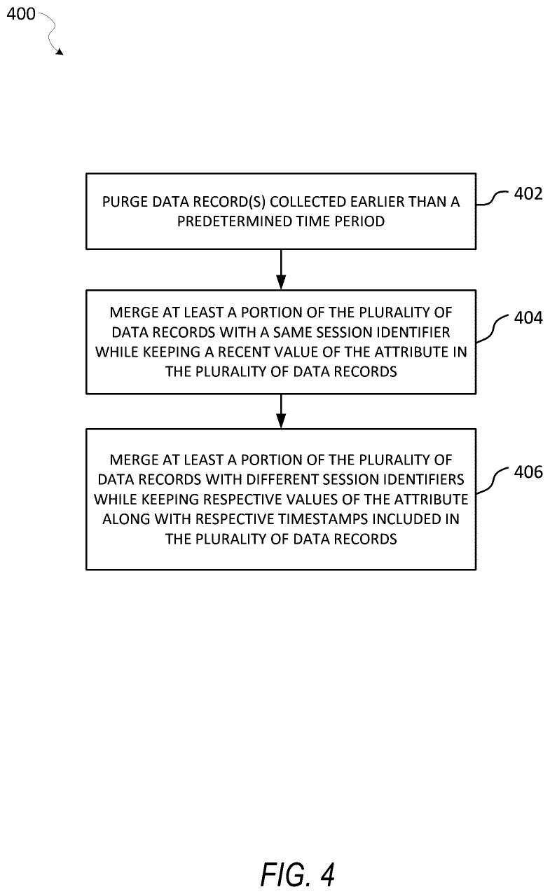

FIG. 4 is a flowchart illustrating an example method 400 for facilitating reconciliation and storage of conflicting user data across multiple platforms, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

In various embodiments, operation 304 in method 300 can include one or more of the operations 402, 404, and 406.

At operation 402, a processor purges one or more data records collected earlier than a predetermined time period. After the predetermined time period, data records can be determined as outdated. Customers can set the criteria for data purging. Outdated or redundant data is often purged to ensure that only relevant and up-to-date information is included in the consolidated dataset (e.g., the summary record). This helps streamline the consolidation process and improves the quality of the consolidated data. This helps manage storage costs and ensures that the system does not dispense computing resources more than necessary to handle outdated and/or irrelevant data.

At operation 404, a processor merges at least a portion of the plurality of data records with the same session identifier while keeping a recent value of the attribute in the plurality of data records.

At operation 406, a processor merges at least a portion of the plurality of data records with different session identifiers while keeping respective values of the attribute along with respective timestamps included in the plurality of data records.

Data merging may be used for harmonizing conflicting or duplicated information. When dealing with conflicting data values or records, merging involves selecting the most accurate or reliable information and incorporating it into the dataset while resolving discrepancies. This helps ensure data consistency and integrity, allowing organizations to address conflicts and discrepancies effectively.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 406 or, alternatively, form part of one or more of operations 402 through 406.

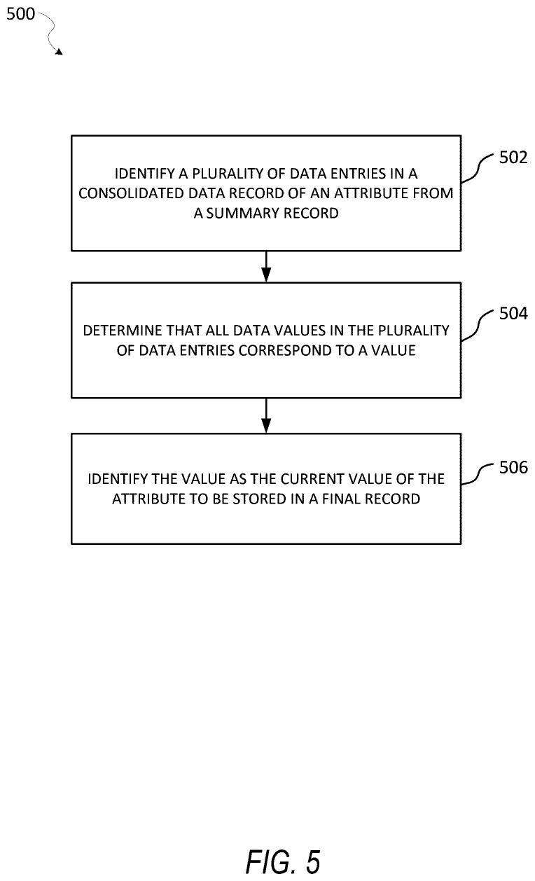

FIG. 5 is a flowchart illustrating an example method 500 for facilitating reconciliation and storage of conflicting user data across multiple platforms, according to various embodiments of the present disclosure. It will be understood that example methods described herein may be performed by a machine in accordance with some embodiments. For example, method 500 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 500 can be performed dependently or independently from operations in method 300 and method 400.

At operation 502, a processor identifies a plurality of data entries in a consolidated data record of an attribute from a summary record.

At operation 504, a processor determines that all data values in the plurality of data entries correspond to a value.

At operation 506, a processor identifies the value as the current value of the attribute to be stored in a final record. The processor designates the identified value as the current value of the attribute to be stored in the final record. By selecting a single, consistent value from the identified data entries, the data management system ensures accuracy in the final record, eliminating potential errors or discrepancies that may arise from conflicting data values.

Though not illustrated, method 500 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 502 through 506 or, alternatively, form part of one or more of operations 502 through 506.

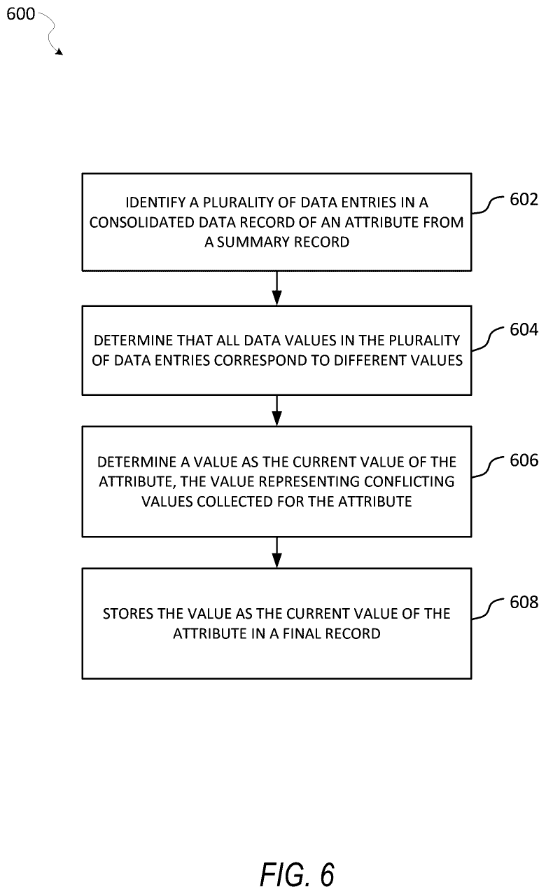

FIG. 6 is a flowchart illustrating an example method 600 for facilitating reconciliation and storage of conflicting user data across multiple platforms, according to various embodiments of the present disclosure. It will be understood that example methods described herein may be performed by a machine in accordance with some embodiments. For example, method 600 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 600 may be represented by executable instructions that, when executed by a processor of a computing device, cause the computing device to perform method 600. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 600 can be performed dependently or independently from operations in method 300, method 400 and method 500.

At operation 602, a processor identifies a plurality of data entries in a consolidated data record of an attribute from a summary record.

At operation 604, a processor determines that all data values in the plurality of data entries correspond to different values.

At operation 606, a processor determines a value as the current value of the attribute. The determined value can be “conflict,” representing conflicting values collected for the attribute.

At operation 608, a processor stores the value (“conflict”) as the current value of the attribute in the final record.

Though not illustrated, method 600 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 602 through 608 or, alternatively, form part of one or more of operations 602 through 608.

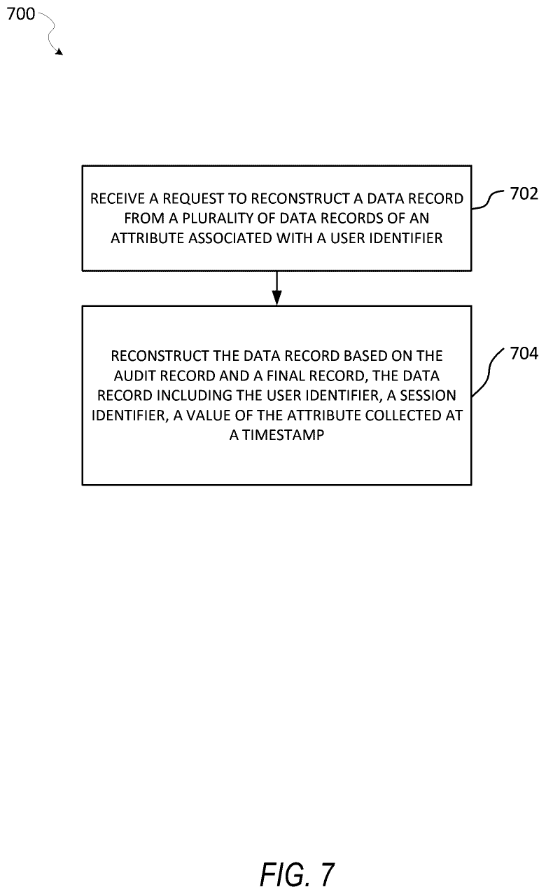

FIG. 7 is a flowchart illustrating an example method 700 for facilitating reconciliation and storage of conflicting user data across multiple platforms, according to various embodiments of the present disclosure. It will be understood that example methods described herein may be performed by a machine in accordance with some embodiments. For example, method 700 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 700 may be represented by executable instructions that, when executed by a processor of a computing device, cause the computing device to perform method 700. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 700 can be performed dependently or independently from operations in method 300, method 400 and method 500.

At operation 702, a processor receives a request to reconstruct a data record from a plurality of data records of an attribute associated with a user identifier.

At operation 704, a processor reconstructs the data record based on the audit record and a final record, the data record including the user identifier, a session identifier, and a value of the attribute collected at a timestamp. This is particularly useful for audit purposes or for resolving disputes. By leveraging the audit record, it is possible to backtrack and reconstruct the sequence of events leading to the current state of the data.

Though not illustrated, method 700 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 702 through 704 or, alternatively, form part of one or more of operations 702 through 704.

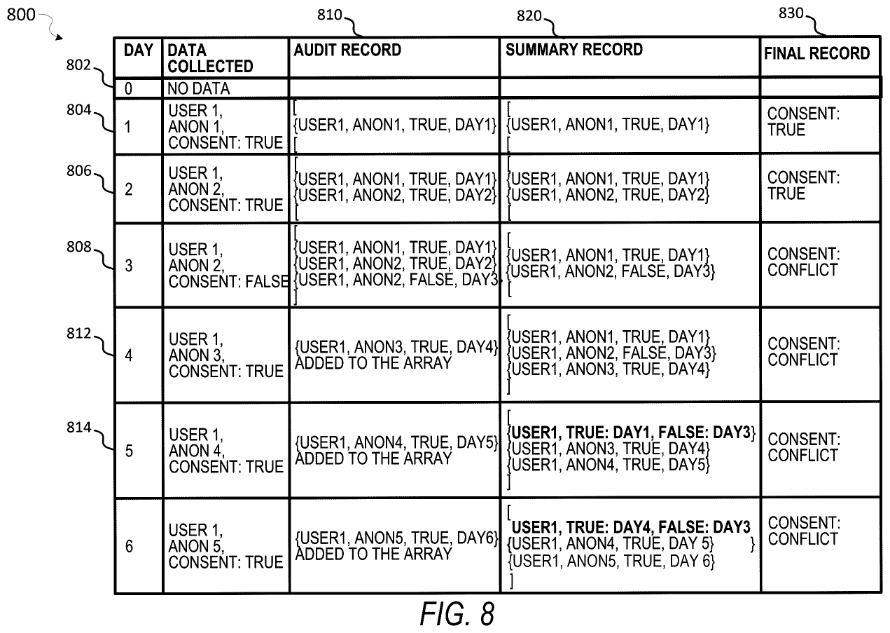

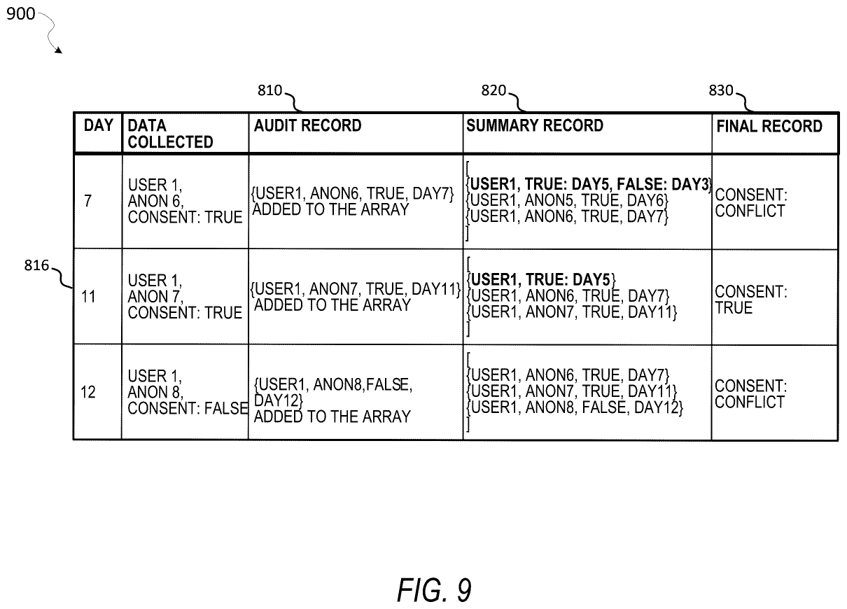

FIGS. 8 and 9 illustrate a spreadsheet showing an example audit record, an example summary record, and an example final record associated with attribute values collected for a user over a period of time, according to various embodiments of the present disclosure.

As shown, on day 0 (row 802), the audit record 810, the summary record 820, and the final record 830 include no data.

On day 1 (row 804), a user in an anonymous session gave consent to a consent preference (e.g., consent preference on the use of personal data). “USER 1” is a user identifier. “ANON 1” is a session identifier, indicating an anonymous session. “TRUE” is the value of the consent preference (as one of the attributes described herein). The data management system writes “{USER1, ANON1, TRUE, DAY1}” to both the audit record and the summary record. Because there is only one value (i.e., TRUE) of the data attribute (i.e., consent preference) collected on day 1, the value generated for the consent preference in the final record is “TRUE.”

On day 2 (row 806), the same user (i.e., USER 1) in anonymous session 2 (“ANON2”) gave consent to the consent preference. The data record “{USER1, ANON2, TRUE, DAY2}” is generated and written in both audit record 810 and summary record 820. Because there is only one value (i.e., TRUE) collected for the data attribute (i.e., consent preference) in the summary record, the value of the consent preference in the final record is “TRUE.”

On day 3 (row 808), USER 1 in the same anonymous session 2 (“ANON2”) denied consent to the consent preference. The data record “{USER1, ANON2, FALSE, DAY3}” is generated and written in audit record 810. Because the user changed the consent preference in the same session (“ANON2”), the second entry of the summary record 820 is updated based on the entry with the most recent value, namely “{USER1, ANON2, FALSE, DAY3}.” Because the collected values of the consent preferences in the summary record include both “TRUE” and “FALSE,” indicating a conflict, the value “CONFLICT” is generated as the value for the consent preference in the final record.

On day 4 (row 812), USER 1 in anonymous session 3 (“ANON3”) gave consent to the consent preference. The data record “{USER1, ANON3, TRUE, DAY4}” is generated and added to the array of entries in audit record 810. The audit record maintains all entries without modification and/or consolidation. This allows reconstructing the state of the data at a specific point in time for either functional, technical, or legal reasons. The same data record is written in the summary record. No consolidation is done for the summary record because the number of entries has not exceeded the threshold value (e.g., 3). The value “CONFLICT” is generated as the value for the consent preference in the final record.

On day 5 (row 814), USER 1 in anonymous session 4 (“ANON4”) gave consent to the consent preference. The data record “{USER1, ANON4, TRUE, DAY5}” is generated and added to the array of entries in audit record 810. Once the data record is added to the summary record, the number of entries will exceed the threshold value. Therefore, the first and second entries are consolidated as “{USER1, TRUE: DAY 1, FALSE: DAY3}” where the values are kept in the consolidated entry. Because the consent preference values in the summary record are conflicting, the value generated for the consent preference in the final record for day 5 is “CONFLICT.”

On day 11 (row 816), data older than 7 days is purged from the summary record. After purging, the entry “{USER1, TRUE: DAY5}” is written in the summary record. Because the consent preference values in the summary record are the same (i.e., “TRUE”), the value generated for the consent preference in the final record for day 11 is “TRUE.” The summary record may be configured to purge data older than any predefined period of time (e.g., 7 days, 1 month, or 3 months), depending on various factors, including without limitation, the data retention policy, storage capacity, performance considerations, data security, business needs, and/or legal requirements.

An ordinary skilled in the art can appreciate that values of a given attribute can be collected at any time interval or as events arrive, not limited to daily intervals, as shown in FIGS. 8 and 9. In addition. the summary record can be configured to allow a number of data entries up to a threshold value. The threshold value can be configured based on the business or technical use cases, or legal requirements.

The summary record helps minimize the processing or decision-making time required to determine the final state or the final record. The summary record also helps minimize active storage size and costs. The audit record includes all the data collected as-is and allows reconstructing the state of the data at a specific point in time for either functional, technical, or legal reasons. The reconstruction can start from the top and recreate the summary and final record. The reconstruction can also start from the end and backtracking updates to recreate the summary and final record.

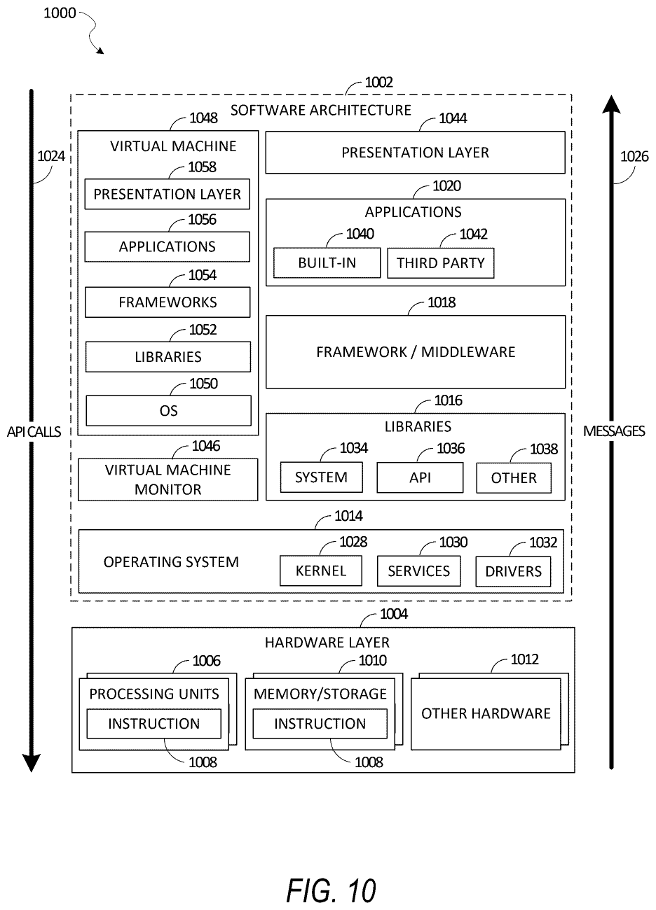

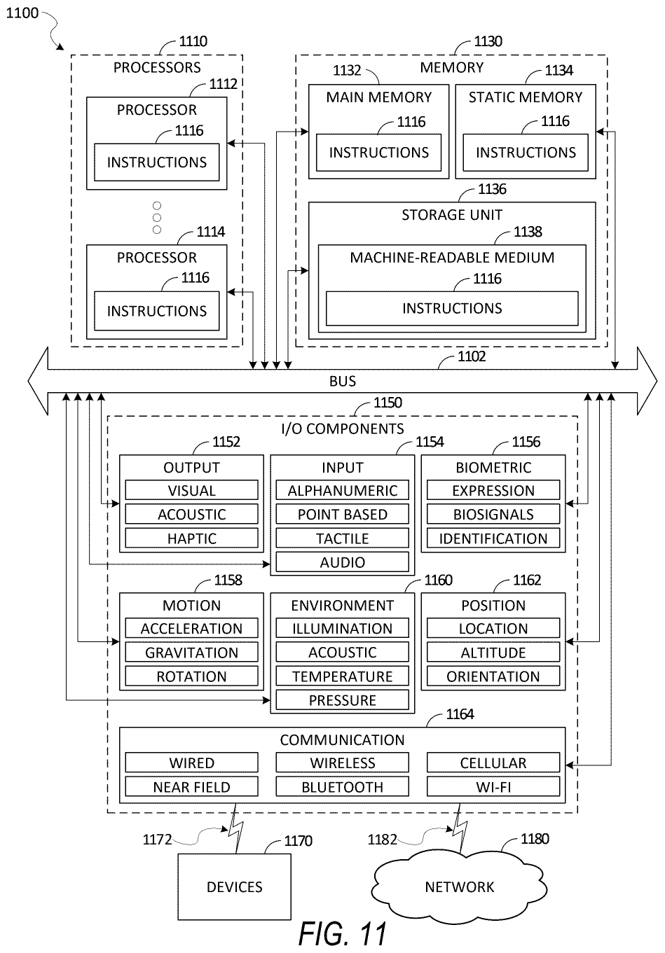

FIG. 10 is a block diagram illustrating an example of a software architecture 1002 that may be installed on a machine, according to some example embodiments. FIG. 10 is merely a non-limiting example of a software architecture, and it will be appreciated that many other architectures may be implemented to facilitate the functionality described herein. The software architecture 1002 may be executing on hardware such as a machine 1100 of FIG. 11 that includes, among other things, processors 1110, memory 1130, and input/output (I/O) components 1170. A representative hardware layer 1104 is illustrated and can represent, for example, the machine 1100 of FIG. 11. The representative hardware layer 1004 comprises one or more processing units 1006 having associated executable instructions 1008. The executable instructions 1008 represent the executable instructions of the software architecture 1002. The hardware layer 1004 also includes memory or storage modules 1010, which also have the executable instructions 1008. The hardware layer 1004 may also comprise other hardware 1012, which represents any other hardware of the hardware layer 1004, such as the other hardware illustrated as part of the machine 1100.

In the example architecture of FIG. 10, the software architecture 1002 may be conceptualized as a stack of layers, where each layer provides particular functionality. For example, the software architecture 1002 may include layers such as an operating system 1014, libraries 1016, frameworks/middleware 1018, applications 1020, and a presentation layer 1044. Operationally, the applications 1020 or other components within the layers may invoke API calls 1024 through the software stack and receive a response, returned values, and so forth (illustrated as messages 1026) in response to the API calls 1024. The layers illustrated are representative in nature, and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 or other software components/modules. For example, the frameworks 1018 may provide various graphical user interface functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a home application, a contacts application, a browser application, a book reader application, a location application, a media application, a messaging application, or a game application.

The third-party applications 1042 may include any of the built-in applications 1040, as well as a broad assortment of other applications. In a specific example, the third-party applications 1042 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1042 may invoke the API calls 1024 provided by the mobile operating system such as the operating system 1014 to facilitate functionality described herein.

The applications 1020 may utilize built-in operating system functions (e.g., kernel 1028, services 1030, or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with the user.

Some software architectures utilize virtual machines. In the example of FIG. 10, this is illustrated by a virtual machine 1048. The virtual machine 1048 creates a software environment where applications/modules can execute as if they were executing on a hardware machine (e.g., the machine 1100 of FIG. 11). The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks 1054, applications 1056, or a presentation layer 1058. These layers of software architecture executing within the virtual machine 1048 can be the same as corresponding layers previously described or may be different.

FIG. 11 illustrates a diagrammatic representation of a machine 1100 in the form of a computer system within which a set of instructions may be executed for causing the machine 1100 to perform any one or more of the methodologies discussed herein, according to an embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute the method 300 described above with respect to FIG. 3, the method 400 described above with respect to FIG. 4, the method 500 described above with respect to FIG. 5, and the method 600 described above with respect to FIG. 6. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an embodiment, the processors 1110 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136 including machine-readable medium 1138, each accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In some examples, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1150 may include biometric components 1156, motion components 1158, environmental components 1160, or position components 1162, among a wide array of other components. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least a portion of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1100 including processors 1110), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 1100, but deployed across a number of machines 1100. In some example embodiments, the processors 1110 or processor-implemented modules are located in a single geographic location (e.g., within a home environment, an office environment, or a server farm). In other example embodiments, the processors or processor-implemented modules are distributed across a number of geographic locations.

The various memories (i.e., 1130, 1132, 1134, and/or the memory of the processor(s) 1110) and/or the storage unit 1136 may store one or more sets of instructions 1116 and data structures (e.g., software) embodying or utilized by any one or more of the methodologies or functions described herein. These instructions (e.g., the instructions 1116), when executed by the processor(s) 1110, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1116 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 1180 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
identifying an audit record that includes a plurality of data records of an attribute;
generating a consolidated data record of the attribute in a summary record based on the plurality of data records of the attribute, the generating of the consolidated data record comprising:
purging one or more data records collected earlier than a predetermined time period,
merging at least a portion of the plurality of data records with a same session identifier while keeping a recent value of the attribute in the plurality of data records, and
merging at least a portion of the plurality of data records with different session identifiers while keeping respective values of the attribute along with respective timestamps included in the plurality of data records;
determining a current value of the attribute based on the consolidated data record of the attribute in the summary record; and
storing the current value of the attribute in a final record for downstream processing.

2. The method of claim 1, wherein the plurality of data records of the attribute is associated with a user identifier, and wherein the user identifier corresponds to one or more session identifiers across a plurality of user devices.

3. The method of claim 1, wherein the attribute corresponds to consent preference configured by a user associated with a user identifier, and wherein the plurality of data records of the attribute includes the consent preference configured by the user over a period of time across a plurality of user devices.

4. The method of claim 1, wherein the audit record is stored in a low-cost archive data storage for long-term data backup retention, and wherein the summary record and the final record are stored in one or more key-value databases.

5. The method of claim 1, wherein the summary record is configured to allow a number of data entries up to a threshold value, wherein the audit record, the summary record, and the final record are associated with a user profile, wherein the user profile includes a plurality of summary records associated with the attribute, and wherein the current value of the attribute is determined based on the consolidated data record of the attribute across the plurality of summary records.

6. The method of claim 1, comprising:
identifying a plurality of data entries in the consolidated data record of the attribute from the summary record.

7. The method of claim 6, comprising:
determining that all data values of the attribute in the plurality of data entries correspond to a value;
identifying the value as the current value of the attribute to be stored in the final record.

8. The method of claim 6, comprising:
determining that all data values of the attribute in the plurality of data entries correspond to different values;
determining a value as the current value of the attribute, the value representing conflicting values collected for the attribute; and
storing the value as the current value of the attribute in the final record.

9. The method of claim 1, comprising:
receiving a request to reconstruct a data record from the plurality of data records of the attribute associated with a user identifier;
reconstructing the data record based on the audit record and the final record generated based on the data record, the data record including the user identifier, a session identifier, a value of the attribute collected at a timestamp.

10. The method of claim 1, wherein one or more of the audit record, the summary record, and the final record comprise one or more database rows, and wherein one or more of the audit record, the summary record, and the final record comprise one or more JavaScript Object Notation (JSON) objects.

11. A system comprising:
one or more computer processors;
one or more computer memories; and
a set of instructions stored in the one or more computer memories, the set of instructions configuring the one or more computer processors to perform operations, the operations comprising:
identifying an audit record that includes a plurality of data records of an attribute;
generating a consolidated data record of the attribute in a summary record based on the plurality of data records of the attribute, the generating of the consolidated data record comprising:
purging one or more data records collected earlier than a predetermined time period,
merging at least a portion of the plurality of data records with a same session identifier while keeping a recent value of the attribute in the plurality of data records, and
merging at least a portion of the plurality of data records with different session identifiers while keeping respective values of the attribute along with respective timestamps included in the plurality of data records;
determining a current value of the attribute based on the consolidated data record of the attribute in the summary record; and
storing the current value of the attribute in a final record for downstream processing.

12. The system of claim 11, wherein the plurality of data records of the attribute is associated with a user identifier, and wherein the user identifier corresponds to one or more session identifiers across a plurality of user devices.

13. The system of claim 11, wherein the attribute corresponds to consent preference configured by a user associated with a user identifier, and wherein the plurality of data records of the attribute includes the consent preference configured by the user over a period of time across a plurality of user devices.

14. The system of claim 11, wherein the audit record is stored in a low-cost archive data storage for long-term data backup retention, wherein the summary record and the final record are stored in one or more key-value databases, wherein the summary record is configured to allow a number of data entries up to a threshold value, wherein the audit record, the summary record, and the final record are associated with a user profile, wherein the user profile includes a plurality of summary records associated with the attribute, and wherein the current value of the attribute is determined based on the consolidated data record of the attribute across the plurality of summary records.

15. The system of claim 11, wherein the operations comprise:
identifying a plurality of data entries in the consolidated data record of the attribute from the summary record.

16. The system of claim 15, wherein the operations comprise:
determining that all data values of the attribute in the plurality of data entries correspond to a value;
identifying the value as the current value of the attribute to be stored in the final record.

17. The system of claim 15, wherein the operations comprise:
determining that all data values of the attribute in the plurality of data entries correspond to different values;
determining a value as the current value of the attribute, the value representing conflicting values collected for the attribute; and
storing the value as the current value of the attribute in the final record

18. The system of claim 11, wherein the operations comprise:
receiving a request to reconstruct a data record from the plurality of data records of the attribute associated with a user identifier;
reconstructing the data record based on the audit record and the final record generated based on the data record, the data record including the user identifier, a session identifier, a value of the attribute collected at a timestamp.

19. The method of claim 1, wherein one or more of the audit record, the summary record, and the final record comprise one or more database rows, and wherein one or more of the audit record, the summary record, and the final record comprise one or more JavaScript Object Notation (JSON) objects.

20. A non-transitory computer-readable medium storing a set of instructions that, when executed by one or more computer processors, causes the one or more computer processors to perform operations, the operations comprising:
identifying an audit record that includes a plurality of data records of an attribute;
generating a consolidated data record of the attribute in a summary record based on the plurality of data records of the attribute, the generating of the consolidated data record comprising:
purging one or more data records collected earlier than a predetermined time period,
merging at least a portion of the plurality of data records with a same session identifier while keeping a recent value of the attribute in the plurality of data records, and
merging at least a portion of the plurality of data records with different session identifiers while keeping respective values of the attribute along with respective timestamps included in the plurality of data records;
determining a current value of the attribute based on the consolidated data record of the attribute in the summary record; and
storing the current value of the attribute in a final record for downstream processing.
